(19) United States
(12) Patent Application Publication
(10) Pub. No.: US 2012/0281394 A1
(43) Pub. Date: Nov. 8, 2012

(54) PORTABLE LIGHT WITH SAFETY LOCK

(76) Inventor: Timothy S. Weber, Audubon, PA (US)

(21) Appl. No.: 13/101,563

(22) Filed: May 5, 2011

(51) Int. Cl. F21L 4/00

(52) U.S. Cl. 362/186

(57) ABSTRACT

A portable light or other device having a safety lock may comprise: a body having an opening; a cover for engaging and covering the opening of the body; and a lock mechanism including a lock member for engaging the body and the cover for preventing removal of the cover from the body unless the lock mechanism is released by a tool, wherein the lock member is retained on the body or on the cover when the lock mechanism is engaged and when the lock mechanism is released. The cover may be a light head or a light source.

The present invention relates to a portable device, e.g., a portable light and, in particular, to a portable device having a lock.

Conventional portable devices including portable lights, e.g., flashlights, typically may be disassembled relatively easily as is convenient for, e.g., replacing a discharged battery. Commonly, either a light head portion of the light or a tail cap portion thereon or both can be unscrewed from the light to gain access to the battery inside the body of the light. Certain conventional portable lights are also sealed, e.g., by gaskets and/or O-rings, so as to resist the entry of undesired substances, e.g., moisture, dirt and debris, and may be sealed to resist entry of water (if intended or likely to be underwater) and/or a hazardous fluid (if intended or likely to be used in a hazardous environment).

Hazardous environments may include, e.g., mines, refineries, repair and maintenance operations, fueling stations, storage sites, industrial and government locations where ignitable concentrations of flammable gases, vapors and/or liquids can exist, usually as a normal or expected occurrence.

Portable devices and lights intended for use in a hazardous environment often are or are required to be certified as being “safe” for use in the intended hazardous environment. Agencies and organizations such as Underwriter's Laboratory (“UL” in the United States), ATEX (Europe) and the Mine Safety and Health Administration (MSHA, part of the Department of Labor in the United States), as well as other organizations and agencies, serve as official or unofficial standard setting and certifying agencies regarding safety. One prior art approach regarding safety is to try to make a device or light that is “intrinsically safe.”

An “intrinsically safe” device or light may have an electrical circuit that is intended to limit the amount of energy that can be produced so that it cannot produce a spark or thermal heat sufficient to cause fire or ignition of a flammable or combustible mixture in air at the lowest ignitable concentration. A portable device or light cannot be claimed to be “intrinsically safe” unless it has been appropriately certified for a particular hazardous condition by an appropriate certifying agency. However, internal energy limited circuitry does not prevent a user from disassembling a device or light while in a hazardous environment.

At present, one or more certifying agencies require that a device, e.g. a flashlight, cannot be certified as “intrinsically safe” or receive a certain safety rating unless it cannot be disassembled in a hazardous location, e.g. the head and/or battery compartment cover cannot be removed, without the use of a tool or a special fastener.

Applicant believes there is a need for a portable device, e.g., a light, that includes a locking arrangement that prevents disassembly without the use of a tool, and in which parts of the lock are captive against misplacement or loss.

Accordingly, a portable light or other device having a safety lock may comprise: a body having an opening; a cover for engaging and covering the opening of the body; and a lock mechanism including a lock member for engaging the body and the cover for preventing removal of the cover from the body unless the lock mechanism is released by a tool, wherein the lock member is retained on the body or on the cover when the lock mechanism is engaged and when the lock mechanism is released. The cover may be a light head or a light source.

### BRIEF DESCRIPTION OF THE DRAWING

The detailed description of the preferred embodiment(s) will be more easily and better understood when read in conjunction with the FIGURES of the Drawing which include:

FIG. 1 is a perspective view of an example embodiment of a portable device, e.g., a light, having a lock thereon;

FIGS. 2A and 2B are different cross-sectional side views of the example portable light having a lock thereon of FIG. 1;

FIG. 3 is a partial view of the example light showing the example lock arrangement thereof;

FIG. 4 is an exploded perspective view of the example lock arrangement of FIG. 3;

FIGS. 5A and 5B are a front view and a side cross-sectional view, respectively, of the portion of the example light showing the example lock in an unlocked or disengaged condition;

FIGS. 6A and 6B are a front view and a side cross-sectional view, respectively, of the portion of the example light showing the example lock in a locked or engaged condition;

FIG. 7A is a side view of the forward end of the example light, FIG. 7B is a cross-sectional view thereof showing an alignment feature thereof, and FIG. 7C is a side view of the body housing thereof showing the alignment feature thereon;

FIG. 8 is a perspective view of an alternative example lock arrangement, FIG. 8A is a cross-sectional view thereof and FIG. 8B is an interior perspective view of an example light head therefor;

FIG. 9 is a perspective view of an alternative example lock arrangement, FIG. 9A is a cross-sectional view thereof and FIG. 9B is an exterior perspective view of an example housing therefor;

FIG. 10 is a perspective view of an alternative example lock arrangement, and FIG. 10A is a cross-sectional view thereof;

FIG. 11 is a perspective view and FIG. 11A is a cross-sectional view of an alternative example lock arrangement;

FIGS. 12A and 12B are perspective views of an alternative example lock arrangement in the engaged and released conditions, respectively, and FIG. 12C is a cross-sectional view thereof;

FIG. 13 is a perspective view of an alternative example lock arrangement, and FIGS. 13A and 13B are perspective views thereof in the engaged and released conditions, respectively, with the cover removed;

FIGS. 14A and 14B are perspective views of an alternative example lock arrangement in a released and in an engaged condition, respectively, and FIG. 14C is an exterior perspective view of an example housing therefor; and

FIG. 15A is a plan view and FIGS. 15B and 15C are cross-sectional views of an alternative example lock arrangement.

In the Drawing, where an element or feature is shown in more than one drawing figure, the same alphanumeric designation may be used to designate such element or feature in each figure, and where a closely related or modified element is shown in a figure, the same alphanumerical designation primed or designated “a” or “b” or the like may be used to designate the modified element or feature. Similarly, similar elements or features may be designated by like alphanumeric designations in different figures of the Drawing and with similar nomenclature in the specification. According to common practice, the various features of the drawing are not to scale, and the dimensions of the various features may be arbitrarily expanded or reduced for clarity, and any value stated in any Figure is given by way of example only.

### DESCRIPTION OF THE PREFERRED EMBODIMENT(S)

An example portable device 10, e.g., a portable light 10, is described that includes an example lock arrangement 300 that precludes the unintentional disassembly of the light. In the example light, battery replacement is effected by unscrewing the light head 200 from the light body 100 to gain access to the compartment (cavity) in light body 100 wherein the battery resides. Lock mechanism 300, if engaged, prevents removal of light head 200 unless a tool is employed to release lock 300. Because a tool is required, light head 200 will not loosen and cannot be removed accidentally or unintentionally—it requires the intentional use of a tool.

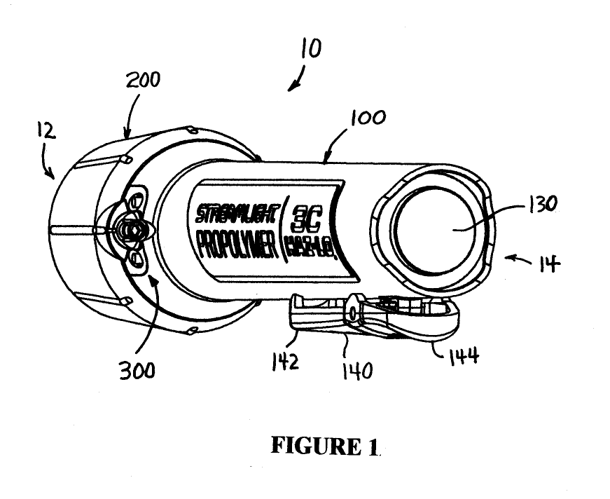

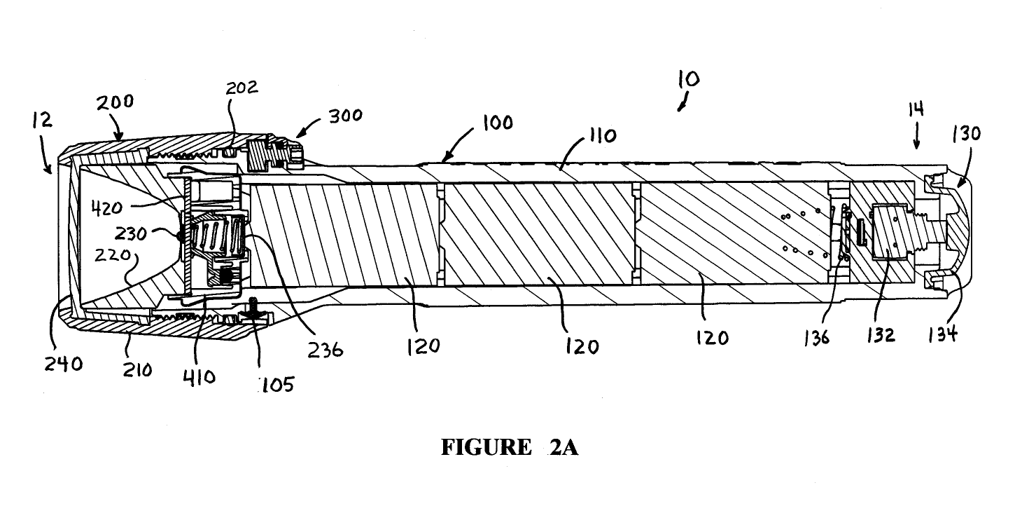

FIG. 1 is a perspective view and FIGS. 2A and 2B are cross-sectional side views of an example portable device 10, e.g., light 10, having an example lock 300 thereon. The cross-sections of FIGS. 2A and 2B are taken at about 90° rotation from each other. Portable device 10 is a flashlight 10 having a light body 100 and a light head 200 or cover 200 containing a light source 230 on a forward or head end 12 thereof. Light body 100 has a switch 130 at a rearward or tail end 14 thereof for controlling the light produced by a light source of light head 200.

Light body 100 comprises a housing 110 which has an internal cavity for receiving one or more battery cells 120 therein and has a spring-biased pivoted clip 140 for attaching light 10 to an object, such as a person, clothing, head wear, helmet, tool, equipment and the like. Clip 140 is pivotably attached to light body 100 by pivot pin 141 which passes through aligned holes through clip 140 and through a projection extending from the exterior of light housing 110. Clip 140 is biased by a spring 143 so that the elongated end 142 thereof remote from pin 141 is biased against housing 110. Clip 140 may have a loop 144 at the other end thereof so that light 10 may be provided with a wrist strap or lanyard or may be hung on an available hook, pin or post or other projection.

Light head 200 at the forward end of light 10 comprises a head housing 210 containing a reflector 220 and light source 230, e.g., a light emitting diode (LED) 230. LED 230 is located at the base of reflector 220 which has a lens 240 covering the open forward end thereof. LED 230 is preferably disposed on an electronic circuit board 420 through which heat generated by LED 230 is coupled to reflector 220 which serves as a heat sink 220. An O-ring 202 may be employed to provide a seal between housing head 210 and body housing 110. Housing 110 may have a pressure relieving vent 105 therein, e.g., disposed in a hole fluidly coupling the interior of housing 110 to the external environment.

Switch 130 at the tail end 14 of light 10 controls operation of light 10 in response to actuation or actuations by a user pressing on actuator 134. Actuator 134 is a flexible membrane or cover that extends, e.g., in a central region, to contact the actuator button of electrical switch 132 located at the rear of housing 110. Cover 134 is circular and has a peripheral ring that engages a circular groove in the rear end 14 of housing 110 so as to provide a seal at the rear end 14 of housing 110. A contact spring 136, e.g., a coil spring 136, provides electrical connection to the rear of series connected batteries 120.

A contact 236 of head 200 makes contact with the forward contact of battery 120, preferably through a central opening that has a diameter that will pass the small diameter projecting positive contact of battery 120, whereby should batteries 120 be inserted with reverse polarity, a reverse polarity voltage that might damage light source 230 and/or circuitry of circuit board 420 can not be applied thereto. In one embodiment, light 10 utilizes three batteries 120 in series, as illustrated, which batteries 120 may be C-size cells, e.g., alkaline battery cells.

Where housing 110 is electrically conductive, the circuit between the switch 130 at the rear 14 of housing 110 and head 200 may be completed by housing 110. Where housing 110 is not electrically conductive, the circuit between the switch 130 at the rear 14 of housing 110 and head 200 may be completed by an electrically conductive strip 146 extending through the battery cavity of housing 110 between switch 130 and head 200. A contact 236, which may be a spring contact 236, at the rear of head 200 provides electrical connection to the forward end of series connected batteries 120, and a ring contact 246 of head 200 may provide electrical connection to conductive housing 100 or the conductive strip 146 therein.

Light head or cover 200 is attached to light body 100 typically by a threaded engagement therebetween so that head 200 may be rotated to engage its internal thread with an external thread of housing 110, thereby to be able to be screwed onto and off of housing 110. In a conventional light, a head 200 or a cover 200 may simply be rotated to be removed from and attached to an end of housing 110. Light 10, however, does not allow such simple removal and attachment which can compromise safety, particularly in a hazardous environment.

Device or light 10 is improved over conventional devices and lights in that it includes a lock 300 that secures light head 200 or cover 200 to body 100 and in that it requires a tool to be disengaged (unlocked). In some embodiments lock 300 may require a tool to be engaged (locked) and in other embodiments lock 300 may not require a tool to be engaged (locked). Preferably, lock 300 also provides a positive indication, e.g., a visual indication, to a user that it is in the engaged (locked) or safe condition or that it is in the disengaged (unlocked) or unsafe condition.

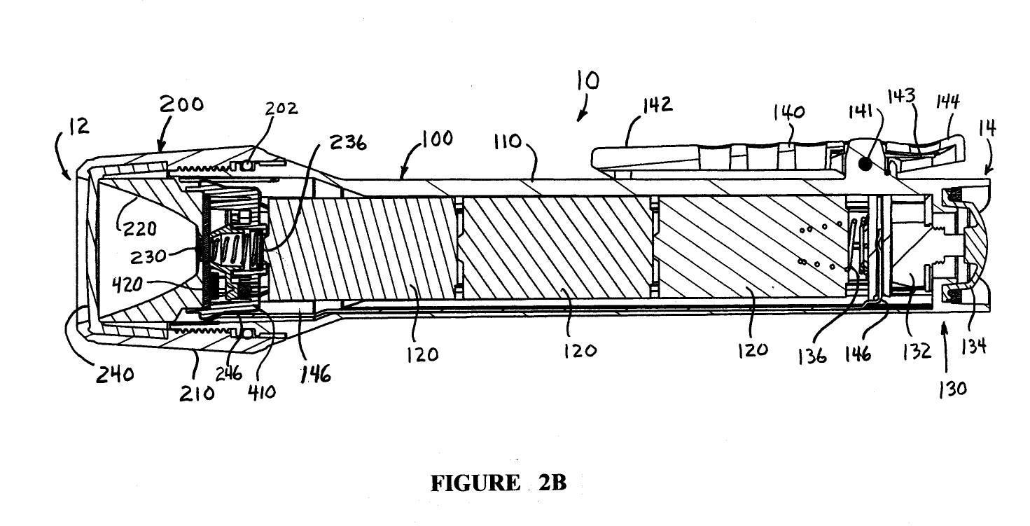

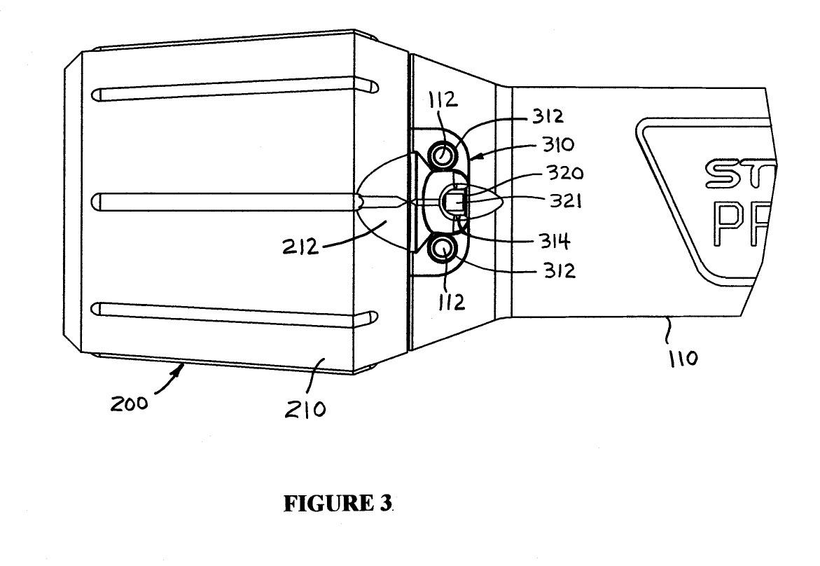

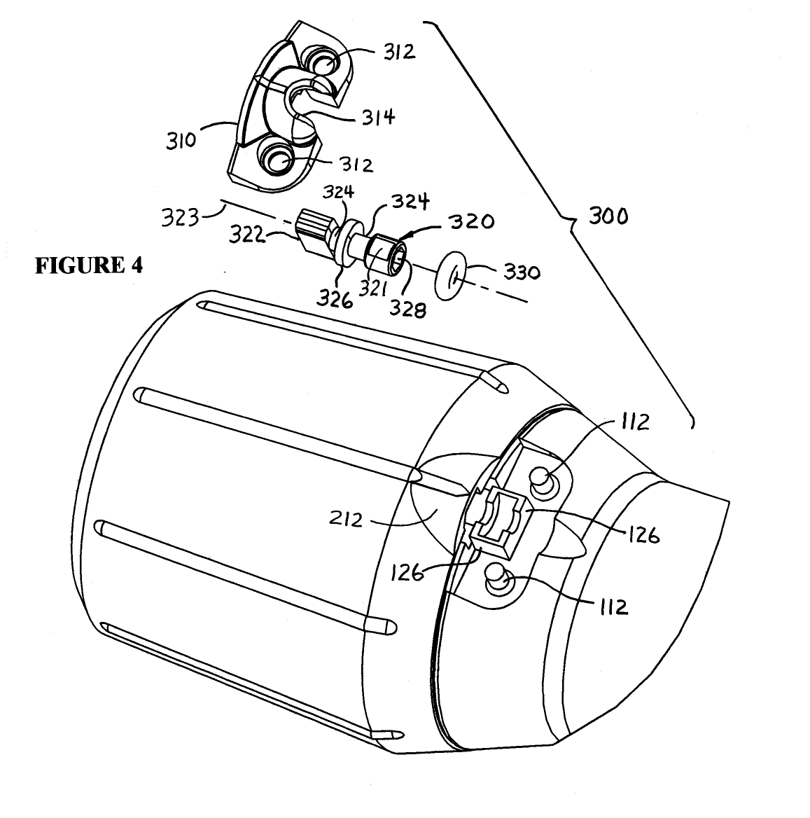

FIG. 3 is a partial view of the example light 10 showing the lock 300 arrangement thereof and FIG. 4 is an exploded view of lock 300 arrangement. Lock 300 comprises a locking member 320 that when locked engages both housing 110 and head housing 210 or a cover 210 to prevent rotation of head housing or cover 210 relative to housing 110 and that when unlocked disengages from one or both of head housing or cover 210 and housing 110 to permit relative rotation thereof, whereby head 200 may be removed (typically, unscrewed) from housing 110. All parts of lock 300 are captive in or on either body housing 100 or light head 200, whereby the parts of lock 300 can not be misplaced or lost.

In example lock 300 of light 10, a locking member 320 is rotatably mounted to light body housing 110 and has a lock blade 322 that extends forward so as to be covered by head housing 210 (as shown) when head 200 is fully screwed onto housing 110 of light body 100. Lock 300 includes a generally C-shaped lock cover 310 that cooperates with features of housing 110 to provide a seat 126, 316 in which lock member 320 is rotatable relative to housing 110 as described below. Cover 310 is placed against housing 110 after lock member 320 is seated therebetween and is secured thereto, e.g., preferably by one or more posts 112 of housing 110 that extend through one or more holes 312 of cover 310 and are then thermally heated and compressed to permanently heat stake cover 310 to housing 110. Cover 310 has a raised protrusion to provide space for seating lock member 320 and head housing 210 has a corresponding protrusion to provide space for a recess 212 for receiving a part 322, e.g., a lock blade 322, of lock member 320 therein.

Lock member 320 comprises a central shaft 324 that has a lock blade 322 at one end thereof and has a tool receiving feature 328 at the other end thereof. Blade 322 is a generally rectangular member that extends radially from shaft 324 in at least one direction so as to sweep an arc when shaft 324 is rotated. In the example shown, blade 322 extends radially from shaft 322 in both directions, thereby to extend outwardly from housing 110 to engage head housing 210 and inwardly to engage light housing 110. Lock blade 322 may have beveled, chamfered and/or rounded edges for facilitating its rotation when in lock 300.

Tool receiving feature 328 or tool interface 328 may be, e.g., a recess into which a tool may be inserted for rotating lock member 320 about the central axis 323 of shaft 324 thereof, or may be a projection 328 onto which a tool may be placed for rotating lock member 320. While tool interface 328 may have any convenient shape, and may have a recess and/or a projection, in one preferred embodiment tool socket 328 has a hexagonal cross-sectional shape for receiving a tool having a hexagonal cross-sectional shape.

Alternatively, tool interface 328 may have a relatively simple or common shape, such as a slot for receiving a flat blade screwdriver or a cruciform shape (a cross “+” shape) for receiving a Philip's head or cross head screwdriver, or socket 328 may have a more complex shape, e.g., such as a ribbed shape for receiving a Torx® driver tool or another less common or even non-standard tool, and/or may be a projection for receiving similar a standard and/or non-standard tool.

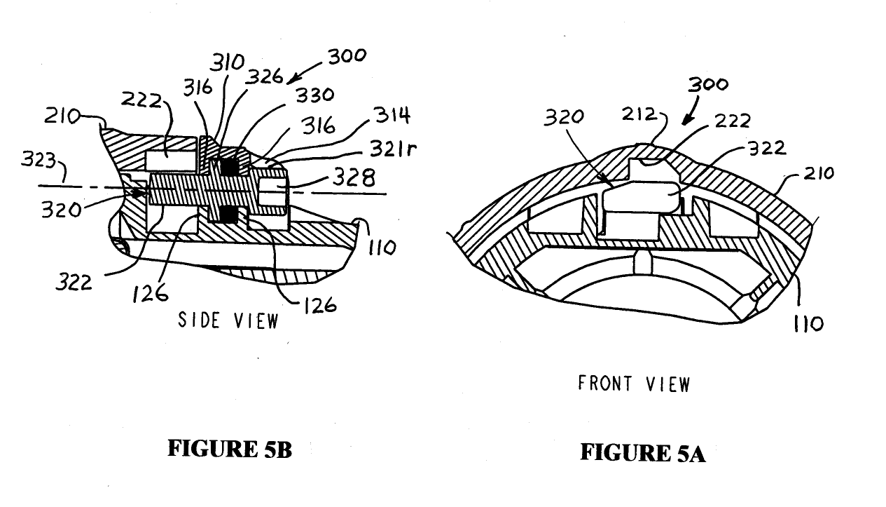

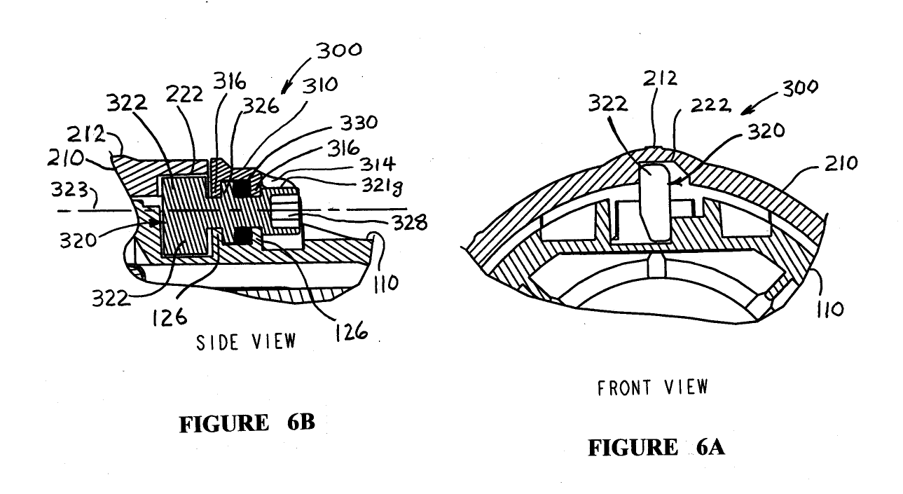

Lock member 320 includes a raised feature 326 for engaging a seat formed by complementary features 126, 316 on the exterior of light housing 110 and on the interior of lock cover 310, as may also be seen in FIGS. 5B and 6B. Feature 326 may be a circular ridge or flange 326 on shaft 324 of lock member 320 and features 126, 316 may be spaced apart walls 126 on light housing 110 and spaced apart walls 316 on cover 310 which align when cover 310 is attached to housing 110, and which may also have curved or semicircular recesses for receiving shaft 324. Preferably, walls 126, 316 allow for rotation of shaft 324 therebetween and are spaced apart more than the thickness of circular flange 326 so as to allow for rotation of shaft 324. More preferably, walls 126, 316 are spaced apart sufficiently to also allow space for a friction providing member so that lock member 320 will remain in the position to which it is rotated when subjected to handling and vibration. A preferred friction member 330 is an O-ring 330 that resides on shaft 324 of lock member 320 adjacent ring flange 326.

Lock cover 310 has an opening 314 out of which shaft 324 of lock member 320 extends for tool feature 328 thereof being positioned to receive a tool for locking and unlocking head 200 and preferably for exposing a portion of lock member 320 that has an indicator 321 of the lock status (condition) thereon. Indicator 321 preferably comprises two different indicator portions corresponding to locked and unlocked conditions. Indicator 321 may be a colored region on the external surface of lock member 321. In one example, one indicator region 321 g is color green indicating a locked or safe condition, e.g., when lock 300 engages head housing or cover 210, and one indicator region 321r is color red indicating an unlocked or open unsafe condition, e.g., when lock 300 is not engaging head housing or cover 210. Where light 10 is a light intended for use in a hazardous environment, a green or safe indicator 321 g indicates that light 10 may be used in an intended hazardous location and a red or unsafe indicator 321r indicates that light 10 should not be used in a hazardous location.

In the arrangement of cover 310 and lock member 320 illustrated, a tool is required to engage lock mechanism 300 and to release lock mechanism 300. Further and optionally therein, a red indicator 321r is located on at the tool socket 328 end of shaft 324 at approximately the same angular location as one flat side of lock blade 322 so as to be visible in opening 314 of cover 310 when lock 300 is disengaged (open) and green indicator 321g is located about 90° radially around therefrom so as to be visible in opening 314 of cover 310 when lock 300 is engaged (closed).

FIGS. 5A and 5B are a front view and a side cross-sectional view, respectively of the portion of the example light 10 showing the lock 300 in an unlocked (i.e. a disengaged or open) condition. In the disengaged position, lock member 320 is rotated so as to rotate blade 322 to be approximately tangential to the exterior surfaces of body housing 110 and head housing 210. In that orientation, lock blade 320 does not engage lock recess 222 of head housing 210, whereby head housing 210 is not restricted by lock 300 from being rotated relative to body housing 110, and so may be removed therefrom.

Lock 300 is locked or engaged by using an appropriate tool to rotate lock member 320 about 90° clockwise so that lock blade 320 thereof rotates into recess 222 of head housing 210 as below. Lock member 320 is held captive to or is retained to light body housing 110 by cover 310 being mounted on light body housing 110, and so no element of lock mechanism 300 is free of light 10 and so can not be misplaced or lost.

FIGS. 6A and 6B are a front view and a side cross-sectional view, respectively, of the portion of the example light 10 showing the lock 300 in a locked condition. In the locked or engaged position, lock member 320 is rotated so as to rotate blade 322 to be approximately radial to body housing 110 and head housing 210. In that orientation, lock blade 320 extends radially outward from body housing 110 to engage lock recess 222 of head housing 210, whereby head housing 210 is restricted by lock member 320 of lock 300 from being rotated relative to body housing 110, and so may not be removed therefrom.

Lock 300 is unlocked or disengaged by using an appropriate tool to rotate lock member 320 about 90° counter-clockwise so that lock blade 320 thereof rotates out of recess 222 of head housing 210 as above.

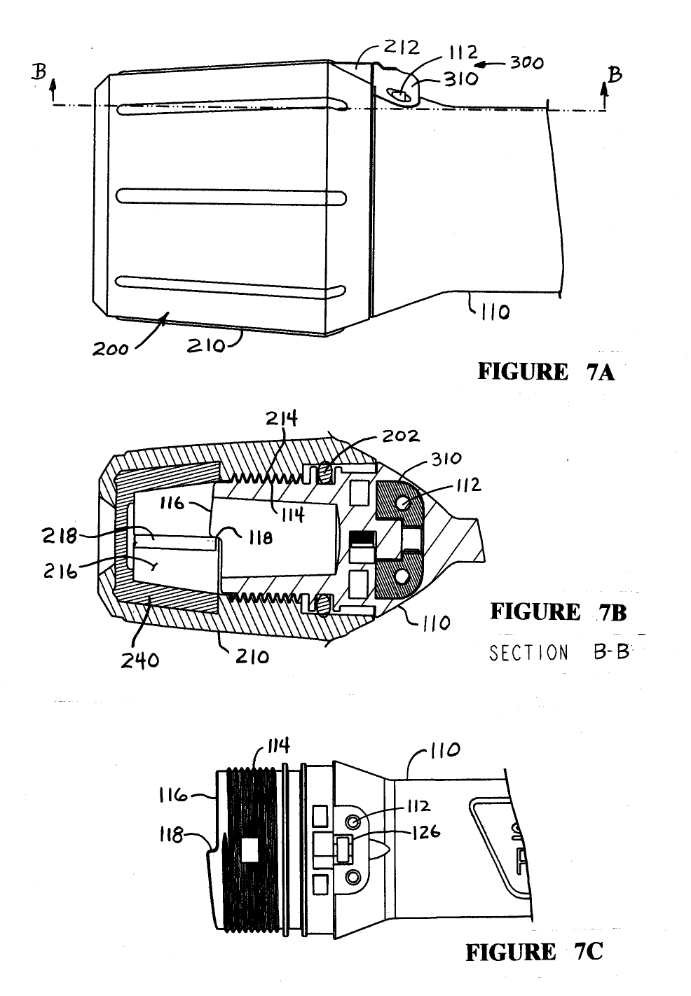

FIG. 7A is a side view of the forward end 12 of the example light 10, FIG. 7B is a cross-sectional view thereof showing an alignment feature 116-118, 216-218 thereof, and FIG. 7C is a side view of the body housing 110 thereof showing the alignment feature 116, 118 thereon. Light head 200 and light body 100 preferably have corresponding features, e.g., projections 118, 218, that engage each other to prevent further rotation of head 200 relative to light body 100 when light head 200 is screwed onto light body 100 to a position whereat the parts of lock 300 of light body 100 are aligned with the parts of lock 300 of light head 200 so that lock 300 may be engaged (locked) and disengaged (released).

Light head 200 typically has internal threads 214 in head housing 210 by which head housing 210 threads onto the external threads 114 at the forward end 12 of light body housing 110. Body housing 110 may have at its circular forward edge 116 a projection 118, e.g., a shoulder 118, that is located at predetermined radial angle relative to lock 300, e.g., may be at about the same radial angle as is the seat 126 for lock member 320.

Light head housing 210 may have a projection 218 on the internal cylindrical surface 216 thereof that extends sufficiently to contact projection 118 at the forward end 116 of light body housing 110 when light head housing 210 is screwed thereon to a position whereat lock 300 can be engaged. Specifically, projection 218 may be a longitudinal ridge or shoulder 218 extending radially inward from the inner surface 216 of head housing 210 in a location and at a predetermined radial angle relative to projection 212 and recess 222 therein, e.g., may be at about the same radial angle as is the projection 212 that defines recess seat 222 for receiving blade 322 of lock member 320 to engage lock 300.

Engaging feature 118 may be defined by a notch or shoulder 118 or other feature near the circular edge 116 at the forward end of housing 110, or any other feature thereat which is at a radial angle and a location to engage a corresponding feature of head 200. Likewise, engaging feature 218 may be defined by a projection, shoulder and/or recess 118 or other feature near the inner surface 216 of light housing 210, or any other feature thereat which is at a radial angle and a location to engage a corresponding feature of light housing 100.

While an alignment feature 118, 218 is a convenient and helpful feature, it is not necessary to the proper operation of lock 300.

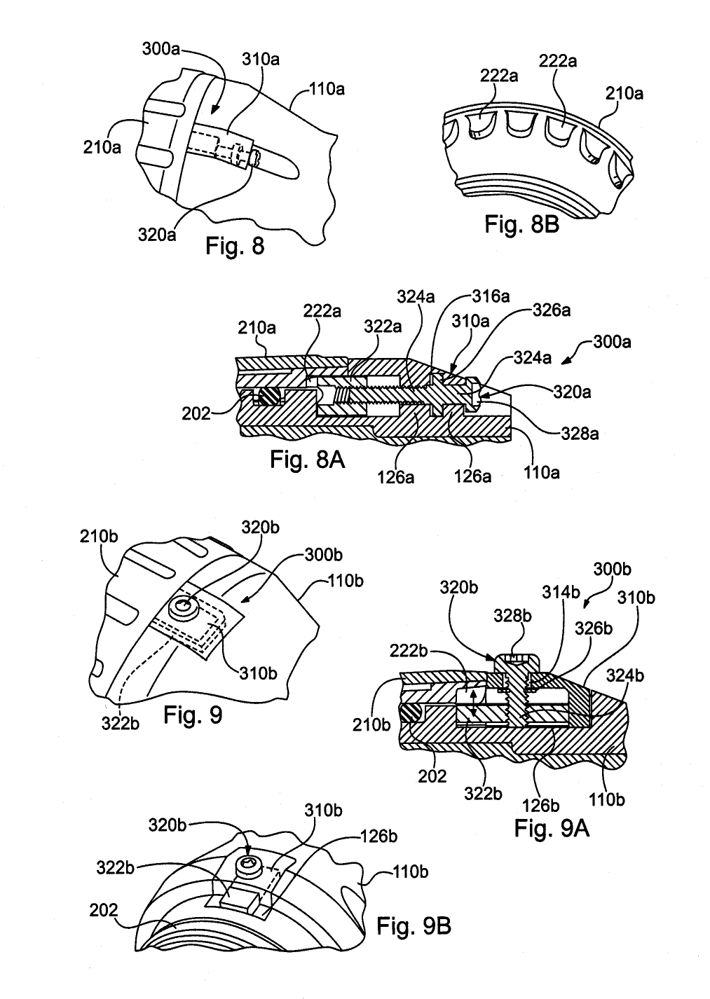

FIG. 8 is a perspective view of an alternative example lock arrangement 300a, FIG. 8A is a cross-sectional view thereof and FIG. 8B is an interior perspective view of an example light head housing 210a therefor. In lock arrangement 300a, a tool is required to engage lock mechanism 300a and to release lock mechanism 300a. Lock member 320a and blade 322a are held captive to or are retained to light body housing 110a by cover 310a being mounted on light body housing 110a, and so no element of lock mechanism 300a is free of light 10 and so can not be misplaced or lost.

Lock arrangement 300a includes lock member 320a rotatable in seat 126a in light housing 110a and retained therein by cover 310a. Lock member 320a has a shaft 324a extending substantially the length thereof with flange ring 326a that is rotatably seated in seat 126a of housing 110a and in groove 316a in the underside of cover 310a, and has receptacle 328a at its exposed end for receiving a tool by which lock member 320a may be rotated. Head housing 210a has one or more ribs defining one or more recesses 222a, and preferably a plurality of recesses 222a, around the rearward end thereof so as to provide a feature or features to which blade 322a of lock member 320a can engage to lock the lock 300a.

The end of shaft 324a is threaded to threadingly engage lock blade 322a so that when lock member 320a is rotated in one direction, blade 322a is moved away from light head housing 210a (e.g., longitudinally or axially relative to housing 110a) so as to disengage from one of recesses 222a therein, thereby to release lock 300a enabling head 210a to be removed from light body 110a. When lock member 320a is rotated in the other direction, blade 322a is moved towards light head housing 210a so as to engage one of recesses 222a therein, thereby to engage lock 300a to prevent head 210a from being removed from light body 110a, at least without a tool being used to rotate lock member 320a in the first direction to release lock 300a.

While recesses 222a may be castellated, e.g., they may have relatively flat ends between the recesses, the ends between recesses may be narrowed and the recesses 222a may be tapered so as to facilitate lock blade 322a entering into one of recesses 222a. Further, the forward end of lock blade 322a may be rounded or tapered so as to facilitate its entering a recess 222a.

FIG. 9 is a perspective view of an alternative example lock arrangement 300b, FIG. 9A is a cross-sectional view thereof and FIG. 9B is an exterior perspective view of an example housing 110b therefor. In lock arrangement 300b, a tool is required to engage lock mechanism 300b and to release lock mechanism 300b. Lock member 320b is held captive to or is retained to cover 310b by retainer 326b and by cover 310b being mounted on light body housing 110b, and so no element of lock mechanism 300b is free of light 10 and so can not be misplaced or lost.

Lock arrangement 300b includes lock member 320b rotatable in an opening 314b in cover 310b which is retained in seat 126b of light housing 110b. Lock member 320b has a shaft 324b extending substantially the length thereof with retaining ring 326b, e.g., an E-ring 326b, that is seated thereon, e.g., in a groove therein, to retain lock member 320b in opening 314b in cover 310b. Lock member 320b has receptacle 328b at its exposed end for receiving a tool by which lock member 320b may be rotated. Head housing 210b has one or more recesses 222b around the rearward end thereof so as to provide features to which blade 322b of lock member 320b can engage to lock the lock 300b.

The end of shaft 324b is threaded to threadingly engage lock blade 322b so that when lock member 320b is rotated in one direction, blade 322b is moved away from seat 126b of light housing 110b (e.g., radially relative to housing 110b) into recess 222b so as to engage recess 222b in head housing 210b, thereby to engage lock 300b to prevent head 210b from being removed from light body 110b, at least without a tool being used to rotate lock member 320b in the opposite direction to release lock 300b. When lock member 320b is rotated in the opposite direction, blade 322b is moved away from light head housing 210b into seat 126b of housing 110b so as to disengage recess 222b in head housing 210b, thereby to release lock 300b to allow head 210b to be removed from light body 110b.

Plural recesses 222b may be provided with the ridges between recesses 222b tapered so as to facilitate lock blade 322b moving into one of recesses 222b. Further, the forward (upper) end of lock blade 322b may be rounded or tapered so as to facilitate its entering a recess 222b.

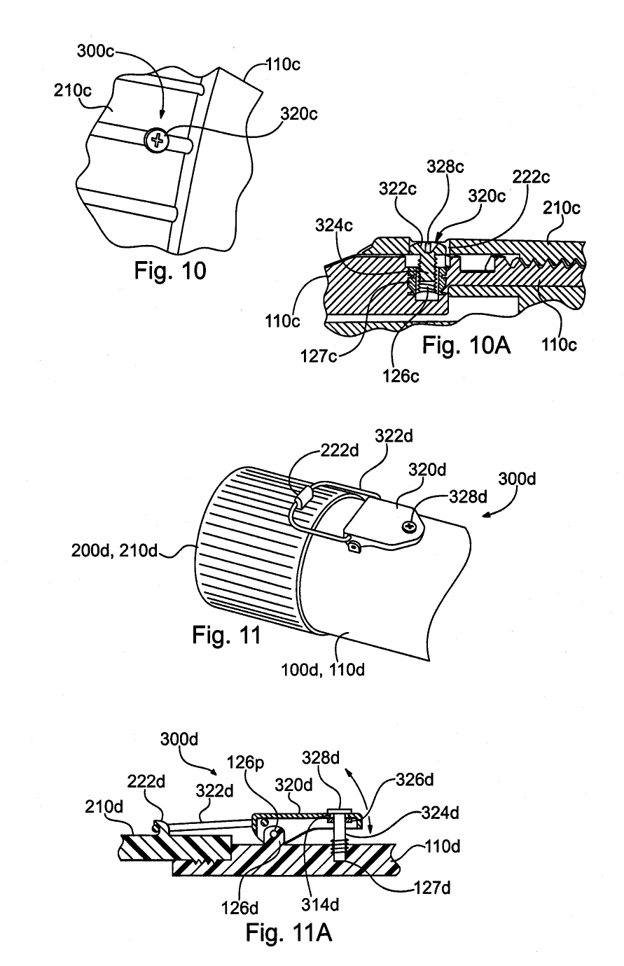

FIG. 10 is a perspective view of an alternative example lock arrangement 300c, and FIG. 10A is a cross-sectional view thereof. Lock arrangement 300c includes lock member 320c rotatable in an opening 222c in housing 210c which is retained in light housing 110c, e.g., by a threaded insert 127c therein. In lock arrangement 300c, a tool is required to engage lock mechanism 300c and to release lock mechanism 300c. Lock member 320c is preferably held captive to or are retained by insert 127c, e.g., by a retainer clip or distorted thread, and insert 127c is embedded in light body housing 110c, and so no element of lock mechanism 300c is free of light 10 and so can not be misplaced or lost.

Lock member 320c has a shaft 324c extending substantially the length thereof with threads at the end thereof engaging threaded insert 127c, and may optionally be retained therein, e.g., by a retainer or by deformed threads and the like. Lock member 320c has receptacle 328c at its exposed end for receiving a tool by which lock member 320c may be rotated. Receptacle 328c may be a slot or a cross-slot for receiving a flat bladed tool (e.g., screwdriver) or a cross-shaped (e.g., Philips head”) tool. Head housing 210c has one or more recesses 222c, e.g., openings 222c, near the rearward end thereof so as to provide features to which head 322c of lock member 320c can engage to lock the lock 300c. Thus, head 322c provides the lock blade 322c for lock 320c. Insert 127c is optional, but preferred, and may be retained in housing 110c by a press fit, by ribs or barbs, by adhesive, by heat staking, by welding or by any other suitable manner.

The end of shaft 324c is threaded to threadingly engage insert 127c so that when lock member 320c is rotated in one direction, head 322c thereof is moved away from seat 126c of light housing 110c (e.g., radially outward relative to housing 110c) into recess 222c of housing 210c so as to engage recess opening 222c in head housing 210c, thereby to engage lock 300c to prevent head 210c from being removed from light body 110c, at least without a tool being used to rotate lock member 320c in the opposite direction to release lock 300c. When lock member 320c is rotated in the opposite direction, head 322c is moved away from light head housing 210c (e.g., radially inward) into seat 126c of housing 110c so as to disengage recess opening 222c in head housing 210c, thereby to release lock 300c to allow head 210c to be removed from light body 110c.

Plural recesses 222c may be provided, and may be tapered so as to facilitate lock blade 322c entering into one of recesses 222c. Further, the head 322c of lock member 320c is preferably rounded or tapered so as to facilitate its entering a recess 222c.

FIG. 11 is a perspective view and FIG. 11A is a cross-sectional view of an alternative example lock arrangement 300d. Lock arrangement 300d includes a pivoting latch arrangement. Therein, light head housing 210d preferably has a projection 222d or locking boss 222d extending therefrom over which a latch clip or loop 322d, e.g., a metal clip or loop 322d, may be placed when head 210d is fully threaded onto the forward end of light body housing 110d. Clip or loop 322d is pivotably attached to latch plate 320d which is pivotably mounted to a projection or boss 126d of light housing 110d, e.g., by a pin or rod 126p.

To release lock 300d, the end of latch plate 320d is moved away from light housing 110d to release lock 300d, e.g., raising latch plate 320d causes the pivot point for clip 322d to move forward thereby to move clip 322d forward to release clip 322d from locking boss 222d so that clip 322d may be lifted off locking boss 222d, thereby freeing head housing 210d for being rotated and removed from light housing 110d.

To engage lock 300d, head housing 210d is threaded onto light housing 110d so that locking boss 222d becomes positioned opposite and aligned with latch plate 320d. Clip 322d may be placed over locking boss 222d, and when the end of latch palate 320d is moved from a raised position toward light housing 110d to engage lock 300d, e.g., so moving latch plate 320d causes the pivot point for clip 322d to move rearward thereby to move clip 322d rearward to retain clip 322d on locking boss 222d, thereby restricting head housing 210d from being rotated and removed from light housing 110d.

Latch plate 320d has an opening therein in which is disposed a screw 324d the threaded shaft of which extends toward light housing 110d for engaging a threaded hole 127d therein. With latch plate 320d in the closed or locked position adjacent housing 110d, screw 324d may be rotated by a tool placed into tool socket 328d so as to advance into hole 127d of light housing 110d thereby to secure latch plate 320d in the locked position and to prevent lock 300d from being released or unlocked without use of a tool. Lock 300d may be released by using the tool to rotate screw 324d in the other direction so that it comes free of hole 127d thereby to permit latch plate 320d to be moved away from housing 110d to release lock 300d.

Preferably, screw 324d is held captive in an opening 314d in lock member 320d, e.g., by a clip or E-ring 326d, or by an un-threaded (smooth) neck, so that it does not become lost. From this location, the head 328d of screw 324d may be rotated causing screw 324d to become threaded into or un-threaded from threaded hole or insert 127d when lock member 320d is in the locking position, thereby to engage or disengage lock 300d.

E-ring 326d is installed on shaft 324d after shaft 324d is inserted into or threaded through hole 314d, either before or after latch plate 320d is attached to housing 110d. Screw 324d of lock member 320d has one or more receptacles 328d at its exposed end for receiving a tool by which screw 324d may be rotated. One example receptacle 328d includes a pair of spaced apart circular recesses for receiving a tool having a corresponding pair of extended pins.

In lock arrangement 300d, a tool is required to engage lock mechanism 300a and to release lock mechanism 300d. Lock member 324d-328d is held captive to or are retained to lock member 320d by retainer clip 326d and to light body 110d by lock member 320d being mounted on light body housing 110d, and so no element of lock mechanism 300d is free of light 10 and so can not be misplaced or lost.

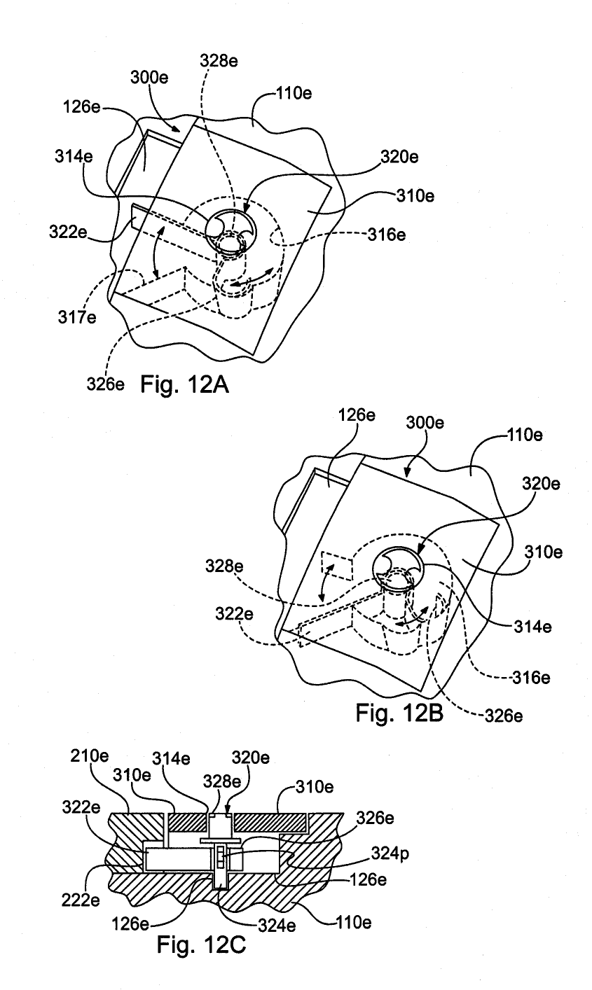

FIGS. 12A and 12B are perspective views of an alternative example lock arrangement 300e in the engaged and released conditions, respectively, and FIG. 12C is a cross-sectional view thereof. Lock 300e preferably is a “ratcheting” type of lock which can lock automatically as head housing 210e is placed onto housing 110e, e.g., without the need of a tool to lock the lock 300e. While a head housing 210e is not shown in these FIGURES, head housing 210e may be similar to head housings 210a, 210b and/or 210d and may have recesses, ridges and/or notches 222e similar to recesses, ridges and notches 222a, 222b and/or 222d of head housings 210a, 210b and/or 210d.

Light housing 110e has a seat 126e therein to receive cover 310e, and lock member 320e and flat spring 326e are retained in seat 126e by cover 310e. Lock member spring 326e has at one end a longer straight portion 322e which provides a lock blade 322e that engages one or more notches or ridges or recesses 222e in the end of a head cover (210e; not shown, but similar to those 210a, 210d of head housing 210a or 210d). Lock member spring 326e has at its other end a curved portion 326e that rotates within seat 126e of housing 110e to engage raised and recessed regions of the side wall thereof which provide positional detents, e.g., for lock member spring 326e to be in an engaging position and in a released position. Lock member 320e has a curved central portion or shaft 324e that includes a projection 324p for engaging an opening or feature of curved spring 326e for lock member 320e rotating spring 320e about an axis that is radial to housing 110e for engaging and releasing lock 300e. Knob and receptacle 328e of lock member 320e is accessible to a tool and resides rotatably in opening 314e of cover 310e. Knob 328e may be a separate piece from spring 326e and is connected to spring 320e by shaft 324e and projection 324p fitting into a central loop thereof.

When lock 300e is engaged, straight end 322e of lock member spring 320e extends through a generally trapezoidal passage 317e of cover 310e and is biased by its spring action against one end of the rectangular end of passage 317e, e.g., parallel to the longitudinal axis of housing 110e, as in FIG. 12A. Since blade 322e is of fixed length, when lock member 320e is rotated about the axis of knob and receptacle 328e, blade 322e traces a circular arc and so extends less until it is within trapezoidal passage 317e, e.g., near the wall angled towards a corner of cover 310e, as in FIG. 12B.

In the position of FIG. 12A, threading head housing 210e onto light housing 110e (e.g., by clockwise rotation) causes ridges 222e at the end of housing 210e to engage and deflect spring blade 322e along the rectangular end of passage 317e until the tip of blade 322e has moved sufficiently rearward to ride over the ridge 222e and to return to the illustrated position ready to engage the next ridge 222e, thereby to ratchet as head housing 210e is placed on housing 110e. Head housing 210e cannot be rotated in the reverse direction (e.g., counter clockwise) because ridges or notches 222e thereon engage blade 322e and press it against the end of the opening of passage 317e, thereby to prevent reverse rotation of head housing 210e which is thus locked on housing 110e. Thus, lock 300e can engage automatically by the ratcheting action of locking member spring 320e.

To release lock 300e, knob and receptacle 328e is rotated counter clockwise by a tool engaging the pair of semi-circular recesses (receptacles) therein to move lock member spring 320e to the position shown in FIG. 12B wherein blade 322e is within trapezoidal passage 317e and does not engage ridges or notches of head housing 210e, and so lock 300e is released. Lock member 320e may be retained in this position by rotational pressure maintained on knob and receptacle 328e against its own bias tending to return blade 322e to the projecting engaging position, or by a detent action between spring end 326e and the side wall of seat 316e.

Plural recesses 222e may be provided in light head 210e and may be castellated, and the sides of recesses 222e may be angled or tapered so as to facilitate lock blade 322e entering into one of recesses 222e. In lock arrangement 300e, lock member 320e and blade 322e are held captive to or are retained to light body housing 110e by cover 310e being mounted on light body housing 110e, and so no element of lock mechanism 300e is free of light 10 and so can not be misplaced or lost.

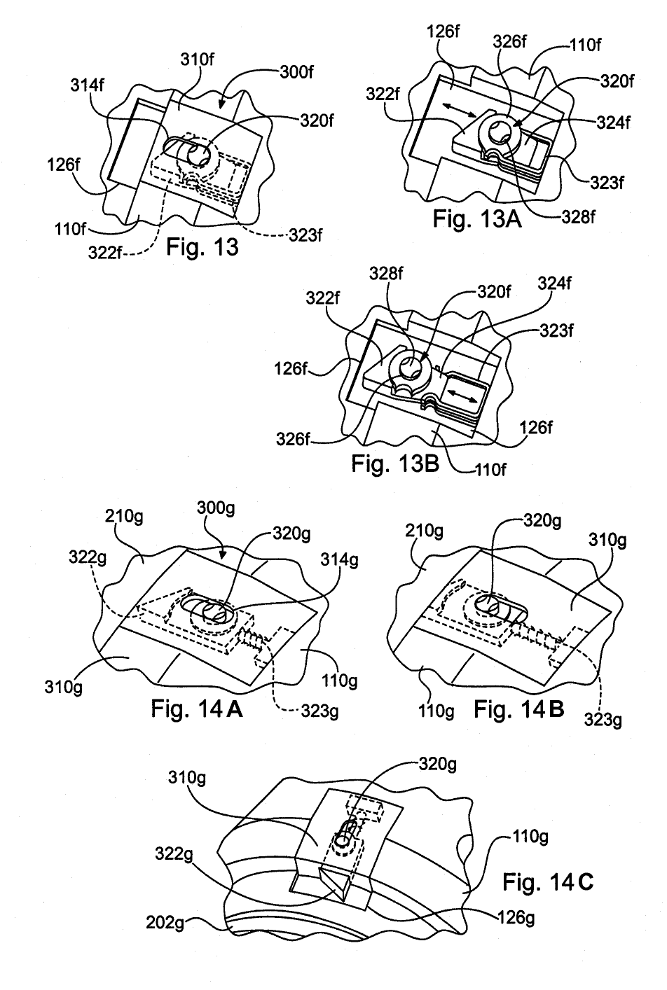

FIG. 13 is a perspective view of an alternative example lock arrangement 300f, and FIGS. 13A and 13B are perspective views thereof in the engaged and released conditions, respectively, with the cover 310f removed. Cover 310f is shown as being removed in FIGURES 13A and 13B so that the interior of lock arrangement 300f may be seen more clearly. Cover 310f resides in seat 126f of housing 110f and has an elongated opening 314f therein for applying force to receptacle 328f of lock member 320f to slide lock member 320f towards or away from head housing 210f. While a head housing 210f is not shown in these FIGURES, head housing 210f may be similar to head housings 210a, 210b and/or 210d and may have recesses, ridges and/or notches 222f similar to recesses, ridges and notches 222a, 222b and/or 222d of head housings 210a, 210b and/or 210d.

Lock 300f comprises a lock member 320f slidingly disposed in seat 126f of light housing 110f for longitudinal movement therein. Lock member 320f comprises a lock blade 322f that has an angled end for ratcheting engagement of ridges or notches on head housing 210f and a tapered or wedge-shaped end 324f. Blade 322f is slid forward to be in position to engage lock 300f and is slid rearward to release lock 300f. One or more U-shaped springs 323f have tips with curved ends that are biased to move close together under its spring action. As a result, sliding lock member 320 away from the forward end of housing 210f (away from head housing 210f) causes springs 323f to be spread apart under tension to exert a force against the tapered end 324f of lock member 320f tending to return lock member 320f to the forward position whereat blade 322f can engage housing 210f.

With lock member 320f in the position of FIG. 13B, threading head housing 210f onto light housing 110f (e.g., by clockwise rotation) causes ridges 222f of housing 210f at the end of housing 210f to engage the angled end of blade 322f to move lock member 320f rearward in seat 126f against the bias of springs 323f until the tip of blade 322f has moved sufficiently rearward for the ridge 222f to ride over blade 322f and to allow blade 322f to return to the illustrated position ready to engage the next ridge 222f, thereby to ratchet lock member 320f as head housing 210f is placed on housing 110f. Head housing 210f cannot be rotated in the reverse direction (e.g., counter clockwise) because ridges or notches 222f thereon engage the straight side of blade 322f and press it against the side of seat 126f, thereby to prevent reverse rotation of head housing 210f which is thus locked on housing 110f. Thus, lock 300f can engage automatically by the ratcheting action of lock member 320f.

Lock member 320f includes a circular knob 326f having receptacle 328f thereon to provide features for engaging by a tool for releasing lock 300f, e.g., by a pair of spaced apart circular or semicircular recesses for being engaged by a tool having a pair of corresponding pins. The tool may be utilized for sliding lock member 320f forward and backward, e.g., to release lock 300f. Circular knob 326f may have a circular recess detent on one edge thereof for receiving a curved tip of spring 323f whereby lock member 320f is restrained in the rearward position against the action of springs 323f tending to move lock member 320f back to the forward or locking position.

Preferably, locking member 320f is free to slide forward and rearward so as to provide a ratcheting locking action, however, knob 326 may be rotatable and so may be rotated by a tool engaging receptacles 328f to rotate knob 326 into position to engage the tip of spring 323f when lock member is moved rearward by the tool. Preferably the edges of exposed features of lock member 320f and slot 314f are too small to be engaged by a human finger and so a tool is needed to release lock 300f. Lock member 320f may be a single piece or knob 326f may be a separate piece from blade 322f and rotatable relative thereto for easier release of spring 323f from the detent position.

While the provided one or plural recesses 222f that lock blade 322f enters may be castellated, the sides of the recesses 222f may be angled or tapered so as to facilitate lock blade 322f entering into one of recesses 222f. Further, the forward end of lock blade 322f may be angled so as to facilitate its entering a recess 222f.

In lock arrangement 300f, a tool is required to engage lock mechanism 300f or to move lock member 320f to an engaging position and a tool is required to release lock mechanism 300f. Lock member 320f and blade 322f are held captive to or are retained to light body housing 110f by cover 310f being mounted on light body housing 110f, and so no element of lock mechanism 300f is free of light 10 and so can not be misplaced or lost.

FIGS. 14A and 14B are perspective views of an alternative example lock arrangement 300g in a released and in an engaged condition, respectively, and FIG. 14C is an exterior perspective view of an example housing 110g therefor. Lock 300g is similar in operation to lock 300f in that a slidable locking member 320g having a blade 322g with an angled end is spring 323g biased forward to provide a ratcheting locking action against ridges or notches of a head housing. While a head housing 210g is not shown in these FIGURES, head housing 210g may be similar to head housings 210a, 210b and/or 210d and may have recesses, ridges and/or notches 222g similar to recesses, ridges and notches 222a, 222b and/or 222d of head housings 210a, 210b and/or 210d.

With lock member 320g in the position of FIG. 14B, threading head housing 210g onto light housing 110g (e.g., by clockwise rotation) causes ridges 222g at the end of housing 210g to engage the angled end of blade 322g to move lock member 320g rearward in seat 126g against the bias of spring 323g until the tip of blade 322g has moved sufficiently rearward for the ridge 222g to ride over blade 322g and to allow blade 322g to return to the illustrated position ready to engage the next ridge 222g, thereby to ratchet lock member 320g as head housing 210g is placed on housing 210g. Head housing 210g cannot be rotated in the reverse direction (e.g., counter clockwise) because ridges or notches 222g thereon engage the straight side of blade 322g and press it against the side of seat 126f, thereby to prevent reverse rotation of head housing 210g which is thus locked on housing 110g. Thus, lock 300g can engage automatically by the ratcheting action of lock member 320g.

Lock member 320g includes a circular knob 326g having receptacle 328g thereon to provide features for engaging by a tool for releasing lock 300g, e.g., by a pair of spaced apart circular or semicircular recesses for being engaged by a tool having a pair of corresponding pins. The tool may be utilized for sliding lock member 320g forward and backward, e.g., to release lock 300g. Circular knob 326g may have a projecting detent on one edge thereof for engaging a corresponding recess of cover 310g whereby lock member 320g may be restrained in the rearward position against the action of spring 323g tending to move lock member 320g back to the forward or locking position.

Preferably, locking member 320g is free to slide forward and rearward so as to provide a ratcheting locking action, however, knob 326g may be rotatable and so may be rotated by a tool engaging receptacles 328g to rotate knob 326g into position to engage cover 310g when lock member is moved rearward by the tool. Preferably the edges of exposed features of lock member 320g and slot 314g are too small to be engaged by a human finger and so a tool is needed to release lock 300g. Lock member 320g may be a single piece or knob 326g may be a separate piece from blade 322g and rotatable relative thereto for engaging cover 310 to retain lock member 320g in the rearward.

While the provided one or plural recesses 222g that lock blade 322g enters may be castellated, the sides of the recesses 222g may be angled or tapered so as to facilitate lock blade 322g entering into one of recesses 222g. Further, the forward end of lock blade 322g may be angled so as to facilitate its entering a recess 222g.

In lock arrangement 300g, a tool is required to engage lock mechanism 300g or to move lock member 320g to an engaging position and a tool is required to release lock mechanism 300g. Lock member 320g and blade 322g are held captive to or are retained to light body housing 110g by cover 310g being mounted on light body housing 110g, and so no element of lock mechanism 300g is free of light 10 and so can not be misplaced or lost.

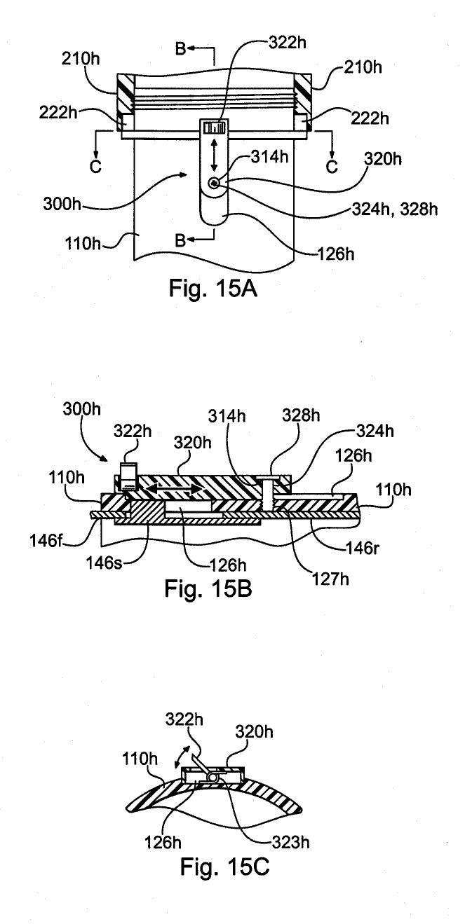

FIG. 15A is a plan view and FIGS. 15B and 15C are cross-sectional views of an alternative example lock arrangement 300h. Lock 310h includes a slidable lock member 320h that is slidable longitudinally along light body 110h so as to be placed in a forward position in which lock 300h may be engaged or in a rearward position in which lock 300h is disengaged. Light body housing 110h preferably has a slot and/or opening 126h therein in which lock member 320h is slidable forwardly and rearwardly. Preferably, opening 126h has a slot 126h through which member 320h extends to connect to slide contact 146s which serves to retain lock member 320h in slot 126h of housing 110h and has a longitudinal groove 126h in which lock member 320 is guided as it slides forwardly and rearwardly. Contact 146s and member 320h may be connected together by a pin, screw, snap, adhesive or other fastener so as to be slidably retained in opening 126h.

In the rearward position, lock member 320h is located sufficiently rearward on light body 110h so as to not engage a light head housing 210h when light head housing 210h is rotated to be threaded onto and off of the threads of light body housing 110h. In the forward position, e.g., as is shown in FIG. 15B, ratchet 322h of lock member 320h is biased by spring 323h to extend radially outward so as to ratchet for engaging ridges and/or recesses 222h in light head housing 210h when light head housing 210h is rotated to be threaded onto the threads of light body housing 110h. Light head housing 210h may have around its rear end one or more ridges and/or recesses that are open at the rear for receiving slidable member 320h therein, e.g., similarly to light head housings 210a, 210b, and/or 210d described herein.

With lock member 320h in the forward position, ratchet 322h is extended under the bias of spring 323h so as to be in position to engage a light head housing 210h when a light head housing 210h (shown in cross-section) is threaded onto light housing 110h. When a ridge 222h of light head housing 210h bears against ratchet 322h as light head 210h is rotated for being threaded onto light body 110h, ratchet 322h is moved thereby toward light body 110h sufficiently to allow the ridge 222a to pass and then ratchet 322h returns to its extended position by spring 323h (as indicated by the double-ended arrow) so as to prevent reversal (un-threading) of light head 210h. As a result, light head 210h is automatically locked onto light body 110h by lock 300h.

Lock member 320h is held in the forward position by screw 324h which engages a threaded hole 127h in light body 110h, e.g., a threaded insert 127h therein. Screw 324h has a tool socket 328h in the end or head thereof into which a tool may be inserted for rotating screw 324h for locking or engaging lock 300h and for disengaging or releasing lock 300h. Locking screw 324h may be configured for retaining slidable lock member 320 in a locked or engaged position in at least two different ways.

In a first configuration, screw 324h is held captive in an opening 314h in slidable lock member 320h, e.g., by a clip, E-ring or un-threaded (smooth) neck, and so the head 328h of screw 324h may be rotated causing screw 324h to become threaded into threaded hole or insert 127h when slidable lock member 320h is slid forward into the locking position, thereby to engage lock 300h. Screw 324h may be rotated in the other direction to become free of hole 127h of light body 110h, thereby to release lock 300h and lock member 320h for being slid forward and rearward into engaging and disengaging positions.

In a second configuration, screw 324h is retained in a threaded hole or insert 127h in light body 110h, e.g., in a threaded insert 127h therein. When screw 324h is rotated so as to be substantially threaded into hole 127h, head 328h thereof is below slidable lock member 320h and so lock member 320h is free to be slid forward and rearward. When lock member 320h is slid forward into the locking or engaging position, opening 314h in slidable lock member 320h is positioned over (e.g., coaxially) with the head 328h of screw 324h. With lock member 320h in this position, the head 328h of screw 324h may be rotated in one direction in threaded hole or insert 127h so as to raise head 328h away from light body 110h into opening 314h thereof, thereby to restrict lock member 320h from being slid and to engage lock 300h. With lock member 320h in this position, the head 328h of screw 324h may be rotated in the other direction in threaded hole or insert 127h so as to retract head 328h towards light body 110h and out of opening 314h thereof, thereby to release lock member 320h for being slid and to disengage lock 300h.

In order to remove light head housing 210h from light body 110h, lock member 320h must be slid rearward so that ratchet 322h thereof slides rearward to become disengaged from ridges and/or recesses 222h of light head 210h whereby light head housing 210h is unlocked (released) and then may be rotated to be removed from light body 110h.

Lock arrangement 300h further includes an electrical contact arrangement 146f, 146r, 146s for rendering light 10 inoperable when lock 300h is not locked or engaged. Electrical conductor 146 of light housing 110h, which provides, e.g., an electrical connection between the rearward end of a battery 120 of light 10 and the light source in head 200 thereof, is configured to have a forward portion 146f and a rearward portion 146r positioned to define a gap or space therebetween. Slidable lock member 320 includes an electrically conductive contact member 146s that slides forwardly and rearwardly with lock member 320 so as to provide or make an electrical connection between conductors 146f and 146r when lock member 320h is slid to the forward or locked position and to break the electrical connection between conductors 146f and 146r when lock member 320h is slid rearwardly from its locking position, e.g., to an unlocked or released position. Slide contact 146s may be in continuous sliding electrical contact with rear conductor 146r for all positions of lock member 320h and in electrical contact with forward conductor 146f only when lock member 320h is in the forward or locking position.

In lock arrangement 300h, a tool is required to retain lock mechanism 300h in the engaged position or to release lock member 320h to be moved from the engaged position, and so a tool is required to release lock mechanism 300h. Lock member 320h, blade 322h and screw 324h are held captive to or are retained to light body housing 110h by their being mounted to light body housing 110h, and so no element of lock mechanism 300h is free of light 10 and so can not be misplaced or lost.

In a typical embodiment of light 10, head housing 210 and light housing 110, including lock 300 cover 310, may be a plastic, e.g. a nylon, ABS, polycarbonate, acetal (POM), or other suitable plastic, with or without reinforcement and/or a filler and/or an anti-static element, e.g., a glass- or carbon-filled plastic. Lens 240 may be polycarbonate, acrylic, ABS, or other suitable plastic or glass. Locking member 320 may be aluminum, brass, copper, steel, stainless steel, plastic or other suitable material, and may have a tool socket 328 that receives a hexagonal or Allen-type wrench, e.g., a 7/64 inch (about 2.8 mm) Allen wrench, a cruciform tool or a spanner-type wrench. Typically, battery 120 is an alkaline battery, typically a C-size alkaline cell, but a carbon-zinc single use battery or a rechargeable lead-acid, Ni-CD, NiMH, or lithium-ion battery could be employed.

A portable light 10 having a safety lock 300-300h comprising: a light body 100, 110-110h having a compartment for receiving a source of electrical power through an opening of the light body 100, 110-110h; a light head 200, 210-210h including a light source 230 for producing light when energized, the light head 200, 210-210h for engaging the opening of the light body 100, 110-110h for covering the compartment thereof; a lock mechanism 300-300h including a lock member 320-320h for engaging the light body 100, 110-110h and the light head 200, 210-210h for preventing removal of the light head 200, 210-210h from the light body 100, 110-110h unless the lock mechanism 300-300h is released by a tool; and a lock cover 310-310h permanently attached to the light body 100, 110-110h or the light head 200, 210-210h for retaining the lock member 320-320h, wherein the lock member 320-320h is retained on the light body 100, 110-110h or on the light head 200, 210-210h by the lock cover 310-310h when the lock mechanism 300-300h is engaged and when the lock mechanism 300-300h is released. The lock member 320-320h may be mounted to one of the light body 100, 110-110h and the light head 200, 210-210h, the lock member 320-320h being movable to a first position for engaging the other of the light body 100, 110-110h and the light head 200, 210-210h and being releasable by a tool from the first position for releasing the other of the light body 100, 110-110h and the light head 200, 210-210h. The lock member 320-320h may comprise: a shaft 324-324h connected to a lock blade 322-322h for engaging and releasing the other of the light body 100, 110-110h and the light head 200, 210-210h, the shaft 324-324h having a tool interface 328-328h for receiving the tool; or a lock blade 322-322h movable for engaging and releasing the other of the light body 100, 110-110h and the light head 200, 210-210h, the lock member 320-320h having a tool interface 328-328h for receiving the tool. lock member 320-320h may comprise: a shaft 324-324h rotatable in a seat on the one of the light body 100, 110-110h and the light head 200, 210-210h, wherein the lock cover 310-310h retains the shaft 324-324h in the seat on the one of the light body 100, 110-110h and the light head 200, 210-210h; or a shaft 324-324h rotatable in a seat on the one of the light body 100, 110-110h and the light head 200, 210-210h, and a retainer engaging the shaft 324-324h for retaining the shaft 324-324h in the seat on the one of the light body 100, 110-110h and the light head 200, 210-210h; or a lock blade 322-322h movable in a seat on the one of the light body 100, 110-110h and the light head 200, 210-210h, wherein the lock cover 310-310h retains the lock blade 322-322h in the seat on the one of the light body 100, 110-110h and the light head 200, 210-210h; or a threaded shaft 324-324h rotatably engaging a threaded hole in one of the light body 100, 110-110h and the light head 200, 210-210h. The lock mechanism 300-300h may be engaged by a tool engaging the lock member 320-320h and may be released by a tool engaging the lock member 320-320h. The lock mechanism 300-300h may make an electrical connection 146, 146s, 146f, 146r in the light body 100, 110-110h when engaged and may break the electrical connection 146, 146s, 146f, 146r when not engaged. The light head 200, 210-210h may have a projection on an internal surface thereof and the light body 100, 110-110h may have a projection thereon, wherein the projection of the light body 100, 110-110h interferes with the projection of the light head 200, 210-210h when the light head 200, 210-210h engages the light body 100, 110-110h for aligning the light head 200, 210-210h and the light body 100, 110-110h for engaging the lock mechanism 300-300h. The lock mechanism 300-300h may provide a visual indication 321 of being engaged, or of being released, or of both. The source of electrical power may include one or more batteries.

A portable device having a safety lock comprising: a body 100, 110-110h having a compartment for receiving a source of electrical power through an opening of the body 100, 110-110h; a cover 200, 210-210h for engaging the opening of the body 100, 110-110h for covering the compartment thereof; a lock mechanism 300-300h including a lock member 320-320h for engaging the body 100, 110-110h and the cover 200, 210-210h for preventing removal of the cover 200, 210-210h from the body 100, 110-110h unless the lock mechanism 300-300h is released by a tool; and a lock cover 310-310h permanently attached to the body 100, 110-110h or the cover 200, 210-210h for retaining the lock member 320-320h, wherein the lock member 320-320h is retained on the body 100, 110-110h or on the cover 200, 210-210h by the lock cover 310-310h when the lock mechanism 300-300h is engaged and when the lock mechanism 300-300h is released. The portable device may be a portable light 10 wherein the cover 200, 210-210h includes a light source 230 for producing light when energized. The lock member 320-320h may be mounted to one of the body 100, 110-110h and the cover 200, 210-210h, the lock member 320-320h being movable to a first position for engaging the other of the body 100, 110-110h and the cover 200, 210-210h and being releasable by a tool from the first position for releasing the other of the body 100, 110-110h and the cover 200, 210-210h. The lock member 320-320h may comprise: a shaft 324-324h connected to a lock blade 322-322h for engaging and releasing the other of the body 100, 110-110h and the cover 200, 210-210h, the shaft 324-324h having a tool interface 328-328h for receiving the tool; or a lock blade 322-322h movable for engaging and releasing the other of the body 100, 110-110h and the cover 200, 210-210h, the lock member 320-320h having a tool interface 328-328h for receiving the tool. The lock member 320-320h may comprise: a shaft 324-324h rotatable in a seat on the one of the body 100, 110-110h and the cover 200, 210-210h, wherein the lock cover 310-310h retains the shaft 324-324h in the seat on the one of the body 100, 110-110h and the cover 200, 210-210h; or a shaft 324-324h rotatable in a seat on the one of the body 100, 110-110h and the cover 200, 210-210h, and a retainer engaging the shaft 324-324h for retaining the shaft 324-324h in the seat on the one of the body 100, 110-110h and the cover 200, 210-210h; or a lock blade 322-322h movable in a seat on the one of the body 100, 110-110h and the cover 200, 210-210h, wherein the lock cover 310-310h retains the lock blade 322-322h in the seat on the one of the body 100, 110-110h and the cover 200, 210-210h; or a threaded shaft 324-324h rotatably engaging a threaded hole in one of the body 100, 110-110h and the cover 200, 210-210h. The lock mechanism 300-300h may be engaged by a tool engaging the lock member 320-320h and may be released by a tool engaging the lock member 320-320h. The lock mechanism 300-300h may make an electrical connection 146, 146s, 146f, 146r in the body 100, 110-110h when engaged and may break the electrical connection 146, 146s, 146f, 146r when not engaged. The cover 200, 210-210h may have a projection on an internal surface thereof and the body 100, 110-110h may have a projection thereon, wherein the projection of the body 100, 110-110h interferes with the projection of the cover 200, 210-210h when the cover 200, 210-210h engages the body 100, 110-110h for aligning the cover 200, 210-210h and the body 100, 110-110h for engaging the lock mechanism 300-300h. The lock mechanism 300-300h may provide a visual indication 321 of being engaged, or of being released, or of both. The source of electrical power may include one or more batteries.

A portable light 10 having a safety lock comprising: a light body 100, 110-110h having a compartment for receiving a source of electrical power through an opening of the light body 100, 110-110h; a cover 200, 210-210h for engaging the opening of the light body 100, 110-110h for covering the compartment thereof; a light source 230 for producing light when energized, wherein the light source 230 is supported by the light body 100, 110-110h or by the cover 200, 210-210h; a lock mechanism 300-300h including a lock member 320-320h for engaging the light body 100, 110-110h and the cover 200, 210-210h for preventing removal of the cover 200, 210-210h from the light body 100, 110-110h unless the lock mechanism 300-300h is released by a tool; and a lock cover 310-310h permanently attached to the light body 100, 110-110h or the cover 200, 210-210h for retaining the lock member 320-320h, wherein the lock member 320-320h is retained on the light body 100, 110-110h or on the cover 200, 210-210h by the lock cover 310-310h when the lock mechanism 300-300h is engaged and when the lock mechanism 300-300h is released. The portable light 10 wherein: the lock member 320-320h may be mounted to one of the light body 100, 110-110h and the cover 200, 210-210h, the lock member 320-320h being movable to a first position for engaging the other of the light body 100, 110-110h and the cover 200, 210-210h and being releasable by a tool from the first position for releasing the other of the light body 100, 110-110h and the cover 200, 210-210h; or the lock member 320-320h may be mounted to one of the light body 100, 110-110h and the light source 200, 210-210h, 230, the lock member 320-320h being movable to a first position for engaging the other of the light body 100, 110-110h and the light source 200, 210-210h, 230 and being releasable by a tool from the first position for releasing the other of the light body 100, 110-110h and the light source 200, 210-210h, 230. The lock member 320-320h may comprise: a shaft 324-324h connected to a lock blade 322-322h for engaging and releasing the other of the light body 100, 110-110h and the cover 200, 210-210h or light source 200, 210-210h, 230, the shaft 324-324h having a tool interface 328-328h for receiving the tool; or a lock blade 322-322h movable for engaging and releasing the other of the light body 100, 110-110h and the cover 200, 210-210h or light source 200, 210-210h, 230, the lock member 320-320h having a tool interface 328-328h for receiving the tool. The lock member 320-320h may comprise: a shaft 324-324h rotatable in a seat on the one of the light body 100, 110-110h and the cover 200, 210-210h or light source 200, 210-210h, 230, wherein the lock cover 310-310h retains the shaft 324-324h in the seat on the one of the light body 100, 110-110h and the cover 200, 210-210h or light source 200, 210-210h, 230; or a shaft 324-324h rotatable in a seat on the one of the light body 100, 110-110h and the cover 200, 210-210h or light source 200, 210-210h, 230, and a retainer engaging the shaft 324-324h for retaining the shaft 324-324h in the seat on the one of the light body 100, 110-110h and the cover 200, 210-210h or light source 200, 210-210h, 230; or a lock blade 322-322h movable in a seat on the one of the light body 100, 110-110h and the cover 200, 210-210h or light source 200, 210-210h, 230, wherein the lock cover 310-310h retains the lock blade 322-322h in the seat on the one of the light body 100, 110-110h and the cover 200, 210-210h or light source 200, 210-210h, 230; or a threaded shaft 324-324h rotatably engaging a threaded hole in one of the light body 100, 110-110h, the light head 200, 210-210h and the cover 200, 210-210h. The lock mechanism 300-300h may be engaged by a tool engaging the lock member 320-320h and may be released by a tool engaging the lock member 320-320h. The lock mechanism 300-300h may make an electrical connection 146, 146s, 146f, 146r in the light body 100, 110-110h when engaged and may break the electrical connection 146, 146s, 146f, 146r when not engaged. The cover 200, 210-210h may have a projection on an internal surface thereof and the light body 100, 110-110h may have a projection thereon, wherein the projection of the light body 100, 110-110h interferes with the projection of the cover 200, 210-210h when the cover 200, 210-210h engages the light body 100, 110-110h for aligning the cover 200, 210-210h and the light body 100, 110-110h for engaging the lock mechanism 300-300h. The lock mechanism 300-300h may provide a visual indication 321 of being engaged, or of being released, or of both. The source of electrical power may include one or more batteries.

A portable light 10 having a safety lock comprising: a light body 100, 110-110h having a compartment for receiving one or more batteries through an open threaded end of the light body 100, 110-110h; a light head 200, 210-210h including a light source 230 for producing light when energized, the light head 200, 210-210h for engaging the open threaded end of the light body 100, 110-110h for covering the compartment thereof; a lock member 320-320h movably retained on one of the light body 100, 110-110h and the light head 200, 210-210h, the lock member 320-320h being movable to a first position for engaging the other of the light body 100, 110-110h and the light head 200, 210-210h and being releasable by a tool from the first position for disengaging the other of the light body 100, 110-110h and the light head 200, 210-210h; a lock cover 310-310h permanently attached to the light body 100, 110-110h or the light head 200, 210-210h for retaining the lock member 320-320h, wherein the lock member 320-320h is retained on the one of the light body 100, 110-110h and the light head 200, 210-210h by the lock cover 310-310h when the lock member 320-320h is engaging the other of the light body 100, 110-110h and the light head 200, 210-210h and when the lock member 320-320h is disengaged from the other of the light body 100, 110-110h and the light head 200, 210-210h; and the lock member 320-320h comprising a shaft 324-324h having a lock blade 322-322h for engaging and releasing at least the other of the light body 100, 110-110h and the light head 200, 210-210h, the shaft 324-324h having a tool interface 328-328h for receiving the tool, wherein the lock member 320-320h engages the light body 100, 110-110h and the light head 200, 210-210h for preventing removal of the light head 200, 210-210h from the light body 100, 110-110h unless the lock member 320-320h is moved by a tool. The lock member 320-320h may be moved for the engaging the other of the light body 100, 110-110h and the light head 200, 210-210h by a tool engaging the lock member 320-320h and may be moved for the releasing the other of the light body 100, 110-110h and the light head 200, 210-210h by a tool engaging the lock member 320-320h. The lock member 320-320h may make an electrical connection 146, 146s, 146f, 146r in the light body 100, 110-110h when engaged and may break the electrical connection 146, 146s, 146f, 146r when not engaged. The light head 200, 210-210h may have a ridge on an internal surface thereof and the light body 100, 110-110h may have a shoulder thereon, wherein the ridge of the light head 200, 210-210h interferes with the shoulder of the light body 100, 110-110h when the light head 200, 210-210h engages the light body 100, 110-110h for aligning the light head 200, 210-210h and the light body 100, 110-110h for engaging the lock member 320-320h.

A portable light 10 having a safety lock comprising: a light body 100, 110-110h having a compartment for receiving one or more batteries through an open threaded end of the light body 100, 110-110h; a light head 200, 210-210h including a light source 230 for producing light when energized, the light head 200, 210-210h for engaging the open threaded end of light body 100, 110-110h for covering the compartment thereof; a lock member 320-320h movably retained on one of the light body 100, 110-110h and the light head 200, 210-210h, the lock member 320-320h being movable to a first position for engaging the other of the light body 100, 110-110h and the light head 200, 210-210h and being releasable by a tool from the first position for disengaging the other of the light body 100, 110-110h and the light head 200, 210-210h; a lock pin 126p permanently attached to the one of the light body 100, 110-110h and the light head 200, 210-210h for retaining lock member 320d, wherein the lock member 320d is retained on the one of the light body 100, 110-110h and the light head 200, 210-210h by the lock pin 126p when lock member 320d is engaging the other of the light body 100, 110-110h and the light head 200, 210-210h and when the lock member 320d is disengaged from the other of the light body 100, 110-110h and the light head 200, 210-210h; and the lock member 320d comprising a latch plate 320d and a latch clip 322d for engaging and releasing at least the other of the light body 100, 110-110h and the light head 200, 210-210h, the lock member 320d further including a screw 328d rotatably and captively mounted to the latch plate 320d and having a tool interface 328d for receiving the tool, wherein the lock member 320d engages the light body 100, 110-110h and the light head 200, 210-210h for preventing removal of light head 200, 210-210h from the light body unless the screw 328d of the lock member 320d is moved by a tool.

As used herein, the term “about” means that dimensions, sizes, formulations, parameters, shapes and other quantities and characteristics are not and need not be exact, but may be approximate and/or larger or smaller, as desired, reflecting tolerances, conversion factors, rounding off, measurement error and the like, and other factors known to those of skill in the art. In general, a dimension, size, formulation, parameter, shape or other quantity or characteristic is “about” or “approximate”whether or not expressly stated to be such. It is noted that embodiments of very different sizes, shapes and dimensions may employ the described arrangements.

Although terms such as “up,” “down,” “left,” “right,” “front,” “rear,” “side,” “top,” “bottom,” “forward,” “backward,” “under” and/or “over,” and the like may be used herein as a convenience in describing one or more embodiments and/or uses of the present arrangement, the articles described may be positioned in any desired orientation and/or may be utilized in any desired position and/or orientation. Such terms of position and/or orientation should be understood as being for convenience only, and not as limiting of the invention as claimed. Similarly, terms such as ridge, rib, recess, shoulder and the like may be used as convenient and interchangeably because ridges and ribs define recesses therebetween and because recesses define ridges or shoulders at their edges. Double-ended arrows are used to indicate the direction or directions of movement for movable parts.

The term battery is used herein to refer to an electro-chemical device comprising one or more electro-chemical cells and/or fuel cells, and so a battery may include a single cell or plural cells, whether as individual units or as a packaged unit. A battery is one example of a type of an electrical power source suitable for a portable device.

While the present invention has been described in terms of the foregoing example embodiments, variations within the scope and spirit of the present invention as defined by the claims following will be apparent to those skilled in the art. For example, while the example embodiment described has a lock in relation to a light head that is removable from the light, the removable part or parts protected by a lock arrangement could be another part of the light, e.g., a tail cap or a battery compartment cover.

Alternatively, tool interface 328-328g may have a relatively simple or common shape, such as a slot for receiving a flat blade screwdriver or a cruciform shape (a cross “+” shape) for receiving a cross-shaped tool, e.g., a Philip's head screwdriver, or interface or receptacle 328 may have a more complex shape, e.g., such as a hexagonal shape for receiving a hexagonal tool, e.g., an Allen wrench, or may have a ribbed wall for receiving a ribbed tool, e.g., a Torx® driver tool, or may have spaced apart recesses for receiving a tool having spaced apart pins, e.g., a spanner wrench, or another less common or even non-standard tool. Moreover, the light or device 10 may have a receptacle or other feature for storing the tool, may have a tool that is connected, e.g., via a tether or lanyard, or may have a tool intended to be kept separate from the light or device, e.g., in a non-hazardous area or under the control of a supervisor or other responsible or designated person.

Further, tool interface is used herein to refer to generally to a tool interface, and need not be a recess, e.g., as would receive a hexagonal or Allen wrench. Such tool interface can be a projection or other feature that receives a tool having a recess or socket, e.g., a triangular, square or hexagonal nut driver, and the like.

Housing 210-210g typically provides a cover for the opening in the light or device body through which a source of electrical power, e.g., a battery, may be placed into a compartment in the light or device body, however, housing 210-210g may be a cover for the opening to the compartment and the light source or other operative element of the light or other portable device may be supported by the light or device body or by another cover or housing.

While cover 310 is in a preferred embodiment heat staked to housing 110 by posts 112, cover 310 may be attached thereto by ultrasonic, heat or chemical welding, by adhesive, by a snap fit, or by another suitable means.

Visual indication 321 indicative of the engaged or released condition of lock 300-300h may be provided by one or more surfaces of lock member 320-320h, or may be provided by any suitable surface that either is exposed when lock 300-300h is engaged and not exposed when lock 300-300h is released, or is hidden when lock 300-300h is engaged and is exposed when lock 300-300h is released, e.g., such as the surface of opening 222c, or of lock blade 322b, or of lock member 320f-320g, or of slot 126h, or an opening in the end of head housing 210a-210b, or another suitable surface or opening.

Where one part is described as having a projection that contacts or engages a recess in another part, the other part may have a projection and the one part may have a recess for effecting engagement, or both parts could have respective projections. In other words, the parts have complementary parts that engage, e.g., engaging features.

In many of the foregoing lock arrangements, e.g., locks 300, 300a, 300b, 300c, 300e, 300f, 300g, 300h, plural recesses 222-222h may be provided and may have castellated ends. The ends between recesses 222-222h may be narrowed and/or the recesses 222-222h may be tapered so as to facilitate lock blade 322-322h entering into one of recesses 222-222h. Further, the forward end of lock blade 322-322h may be rounded or tapered so as to facilitate its entering a recess 222-222h.

Each of the U.S. Provisional Applications, U.S. Patent Applications, and/or U.S. Patents identified herein are hereby incorporated herein by reference in their entirety, for any purpose and for all purposes irrespective of how it may be referred to herein.

Finally, numerical values stated are typical or example values, are not limiting values, and do not preclude substantially larger and/or substantially smaller values. Values in any given embodiment may be substantially larger and/or may be substantially smaller than the example or typical values stated.

What is claimed is:

1. A portable light having a safety lock comprising:
a light body having a compartment for receiving a source of electrical power through an opening of said light body;
a light head including a light source for producing light when energized, said light head for engaging the opening of said light body for covering the compartment thereof;
a lock mechanism including a lock member for engaging said light body and said light head for preventing removal of said light head from said light body unless said lock mechanism is released by a tool; and
a lock cover permanently attached to said light body or said light head for retaining said lock member,
wherein said lock member is retained on said light body or on said light head by said lock cover when said lock mechanism is engaged and when said lock mechanism is released.

2. The portable light of claim 1 wherein said lock member is mounted to one of said light body and said light head, said lock member being movable to a first position for engaging the other of said light body and said light head and being releasable by a tool from the first position for releasing the other of said light body and said light head.

3. The portable light of claim 2 wherein said lock member comprises:
a shaft connected to a lock blade for engaging and releasing the other of said light body and said light head, the shaft having a tool interface for receiving the tool; or
a lock blade movable for engaging and releasing the other of said light body and said light head, the lock member having a tool interface for receiving the tool.

4. The portable light of claim 2 wherein said lock member comprises:
a shaft rotatable in a seat on the one of said light body and said light head, wherein said lock cover retains the shaft in the seat on the one of said light body and said light head; or
a shaft rotatable in a seat on the one of said light body and said light head, and a retainer engaging the shaft for retaining the shaft in the seat on the one of said light body and said light head; or
a lock blade movable in a seat on the one of said light body and said light head, wherein said lock cover retains the lock blade in the seat on the one of said light body and said light head; or
a threaded shaft rotatably engaging a threaded hole in one of said light body and said light head.

5. The portable light of claim 1 wherein said lock mechanism is engaged by a tool engaging said lock member and is released by a tool engaging said lock member.

6. The portable light of claim 1 wherein said lock mechanism makes an electrical connection in said light body when engaged and breaks the electrical connection when not engaged.

7. The portable light of claim 1 wherein said light head has a projection on an internal surface thereof and wherein said light body has a projection thereon, wherein the projection of said light body interferes with the projection of said light head when said light head engages said light body for aligning said light head and said light body for engaging said lock mechanism.

8. The portable light of claim 1 wherein said lock mechanism provides a visual indication of being engaged, or of being released, or of both.

9. The portable light of claim 1 wherein the source of electrical power includes one or more batteries.

10. A portable device having a safety lock comprising:
a body having a compartment for receiving a source of electrical power through an opening of said body;
a cover for engaging the opening of said body for covering the compartment thereof;
a lock mechanism including a lock member for engaging said body and said cover for preventing removal of said cover from said body unless said lock mechanism is released by a tool; and
a lock cover permanently attached to said body or said cover for retaining said lock member,
wherein said lock member is retained on said body or on said cover by said lock cover when said lock mechanism is engaged and when said lock mechanism is released.

11. The portable device of claim 10 wherein said device is a portable light and wherein said cover includes a light source for producing light when energized.

12. The portable device of claim 10 wherein said lock member is mounted to one of said body and said cover, said lock member being movable to a first position for engaging the other of said body and said cover and being releasable by a tool from the first position for releasing the other of said body and said cover.

13. The portable device of claim 12 wherein said lock member comprises:
a shaft connected to a lock blade for engaging and releasing the other of said body and said cover, the shaft having a tool interface for receiving the tool; or
a lock blade movable for engaging and releasing the other of said body and said cover, the lock member having a tool interface for receiving the tool.

14. The portable device of claim 12 wherein said lock member comprises:
a shaft rotatable in a seat on the one of said body and said cover, wherein said lock cover retains the shaft in the seat on the one of said body and said cover; or
a shaft rotatable in a seat on the one of said body and said cover, and a retainer engaging the shaft for retaining the shaft in the seat on the one of said body and said cover; or
a lock blade movable in a seat on the one of said body and said cover, wherein said lock cover retains the lock blade in the seat on the one of said body and said cover; or
a threaded shaft rotatably engaging a threaded hole in one of said body and said cover.

15. The portable device of claim 10 wherein said lock mechanism is engaged by a tool engaging said lock member and is released by a tool engaging said lock member.

16. The portable device of claim 10 wherein said lock mechanism makes an electrical connection in said body when engaged and breaks the electrical connection when not engaged.

17. The portable device of claim 10 wherein said cover has a projection on an internal surface thereof and wherein said body has a projection thereon, wherein the projection of said body interferes with the projection of said cover when said cover engages said body for aligning said cover and said body for engaging said lock mechanism.

18. The portable device of claim 10 wherein said lock mechanism provides a visual indication of being engaged, or of being released, or of both.

19. The portable device of claim 10 wherein the source of electrical power includes one or more batteries.

20. A portable light having a safety lock comprising:
a light body having a compartment for receiving a source of electrical power through an opening of said light body;
a cover for engaging the opening of said light body for covering the compartment thereof;
a light source for producing light when energized, wherein said light source is supported by said light body or by said cover;
a lock mechanism including a lock member for engaging said light body and said cover for preventing removal of said cover from said light body unless said lock mechanism is released by a tool; and
a lock cover permanently attached to said light body or said cover for retaining said lock member,
wherein said lock member is retained on said light body or on said cover by said lock cover when said lock mechanism is engaged and when said lock mechanism is released.

21. The portable light of claim 20 wherein:
said lock member is mounted to one of said light body and said cover, said lock member being movable to a first position for engaging the other of said light body and said cover and being releasable by a tool from the first position for releasing the other of said light body and said cover; or
said lock member is mounted to one of said light body and said light source, said lock member being movable to a first position for engaging the other of said light body and said light source and being releasable by a tool from the first position for releasing the other of said light body and said light source.

22. The portable light of claim 21 wherein said lock member comprises:
a shaft connected to a lock blade for engaging and releasing the other of said light body and said cover or light source, the shaft having a tool interface for receiving the tool; or
a lock blade movable for engaging and releasing the other of said light body and said cover or light source, the lock member having a tool interface for receiving the tool.

23. The portable light of claim 21 wherein said lock member comprises:
a shaft rotatable in a seat on the one of said light body and said cover or light source, wherein said lock cover retains the shaft in the seat on the one of said light body and said cover or light source; or
a shaft rotatable in a seat on the one of said light body and said cover or light source, and a retainer engaging the shaft for retaining the shaft in the seat on the one of said light body and said cover or light source; or
a lock blade movable in a seat on the one of said light body and said cover or light source, wherein said lock cover retains the lock blade in the seat on the one of said light body and said cover or light source; or
a threaded shaft rotatably engaging a threaded hole in one of said light body, said light head and said cover.

24. The portable light of claim 20 wherein said lock mechanism is engaged by a tool engaging said lock member and is released by a tool engaging said lock member.

25. The portable light of claim 20 wherein said lock mechanism makes an electrical connection in said light body when engaged and breaks the electrical connection when not engaged.

26. The portable light of claim 20 wherein said cover has a projection on an internal surface thereof and wherein said light body has a projection thereon, wherein the projection of said light body interferes with the projection of said cover when said cover engages said light body for aligning said cover and said light body for engaging said lock mechanism.

27. The portable light of claim 20 wherein said lock mechanism provides a visual indication of being engaged, or of being released, or of both.

28. The portable light of claim 20 wherein the source of electrical power includes one or more batteries.

29. A portable light having a safety lock comprising:
a light body having a compartment for receiving one or more batteries through an open threaded end of said light body;
a light head including a light source for producing light when energized, said light head for engaging the open threaded end of said light body for covering the compartment thereof;
a lock member movably retained on one of said light body and said light head, said lock member being movable to a first position for engaging the other of said light body and said light head and being releasable by a tool from the first position for disengaging the other of said light body and said light head;
a lock cover permanently attached to said one of said light body and said light head for retaining said lock member,
wherein said lock member is retained on the one of said light body and said light head by said lock cover when said lock member is engaging the other of said light body and said light head and when said lock member is disengaged from the other of said light body and said light head; and
said lock member comprising a shaft having a lock blade for engaging and releasing at least the other of said light body and said light head, the shaft having a tool interface for receiving the tool,
wherein said lock member engages said light body and said light head for preventing removal of said light head from said light body unless said lock member is moved by a tool.

30. The portable light of claim 29 wherein said lock member is moved for the engaging the other of said light body and said light head by a tool engaging said lock member and is moved for the releasing the other of said light body and said light head by a tool engaging said lock member.

31. The portable light of claim 29 wherein said lock member makes an electrical connection in said light body when engaged and breaks the electrical connection when not engaged.

32. The portable light of claim 29 wherein said light head has a ridge on an internal surface thereof and wherein said light body has a shoulder thereon, wherein the ridge of said light head interferes with the shoulder of said light body when said light head engages said light body for aligning said light head and said light body for engaging said lock member.

33. A portable light having a safety lock comprising:
a light body having a compartment for receiving one or more batteries through an open threaded end of said light body;
a light head including a light source for producing light when energized, said light head for engaging the open threaded end of said light body for covering the compartment thereof;
a lock member movably retained on one of said light body and said light head, said lock member being movable to a first position for engaging the other of said light body and said light head and being releasable by a tool from the first position for disengaging the other of said light body and said light head;
a lock pin permanently attached to said one of said light body and said light head for retaining said lock member,
wherein said lock member is retained on the one of said light body and said light head by said lock pin when said lock member is engaging the other of said light body and said light head and when said lock member is disengaged from the other of said light body and said light head; and
said lock member comprising a latch plate and a latch clip for engaging and releasing at least the other of said light body and said light head, said lock member further including a screw rotatably and captively mounted to the latch plate and having a tool interface for receiving the tool,
wherein said lock member engages said light body and said light head for preventing removal of said light head from said light body unless the screw of said lock member is moved by a tool.
